(19) United States
(12) Patent Application Publication
(10) Pub. No.: US 2016/0197451 A1
(43) Pub. Date: Jul. 7, 2016

(54) LASER CONTROL SYSTEM AND METHOD

(71) Applicant: Attodyne Lasers Inc., Toronto (CA)

(72) Inventors: Darren Kraemer, Toronto (CA); Tom Fortin, Sudbury (CA)

(21) Appl. No.: 14/996,315

(22) Filed: Jan. 15, 2016

Related U.S. Application Data
(63) Continuation of application No. PCT/CA2014/050670, filed on Jul. 15, 2014.
(60) Provisional application No. 61/846,790, filed on Jul. 16, 2013.

(51) Int. Cl. H01S 3/10; H01S 3/13; H01S 3/094

(52) U.S. Cl. CPC H01S 3/10069; H01S 3/094076; H01S 3/1301; H01S 3/10015

(57) ABSTRACT

In a laser control system, control circuit, and method, a master oscillator laser generates a seed laser pulse train. An optical modulator receives the pulse train and modulate the pulse train based on a modulation signal to generate modulated seed pulses. A laser amplifier amplifies the modulated seed pulses to generate an amplified pulse sequence output. A control circuit controls the operation of the optical modulator. The control circuit receives a clock signal synchronized with the seed laser pulse train and a trigger input for asynchronous modulation of the seed laser pulse train, generates the modulation signal, and communicates the modulation signal to the optical modulator. The modulation signal controls the optical modulator to selectively transmit and attenuate seed pulses from the seed laser pulse train to produce modulated seed pulses corresponding to the trigger input and attenuated to maintain a predetermined amplitude envelope in the pulse sequence output.

### CROSS-REFERENCE TO RELATED APPLICATIONS

The present application claims priority from U.S. provisional patent application No. 61/840,790, filed Jul. 16, 2013, the entirety of which is hereby incorporated by reference.

### TECHNICAL FIELD

The present application relates to photonics. More particularly, the present application relates to pulsed laser interfacing and the control of asynchronous pulsing of amplified lasers.

### BACKGROUND

Pulse to pulse energy stability is important for precision and reproducibility in certain laser-material processing applications. Pulse to pulse stability can be <1% root mean squared (RMS) in a well designed amplified laser system operating under steady state conditions. However, in many practical processing tasks, the laser must be triggered by motion control equipment that is not synchronized. Asynchronous triggering can cause transient conditions in the laser amplifier which disturb the pulse energy stability.

Pulse Energy and repetition rate are inversely related in a Master Oscillator Power Amplifier (MOPA) laser close to saturation of the amplifiers. In one method of asynchronous triggering, a MOPA laser system is pulsed at a constant repetition rate and gain level, while an optical modulator is used at the output of the laser system to gate the output pulses according to an external trigger However, in at least some applications, this approach may have disadvantages. For example, it limits the timing resolution to an integer factor of the steady state repetition rate, and it requires an optical modulator with a large enough aperture to transmit the laser output without optical damage. For high-throughput laser machining applications, both of these limitations reduce speed and increase cost.

Another method to suppress first pulses has been demonstrated in Q-switch or other pulsed lasers involving limiting the gain. Examples of US patents that relate to the field include U.S. Pat. Nos. 8,081,668; 4,337,442 and 7,876,498.

### SUMMARY OF EXAMPLE EMBODIMENTS

According to one example, a laser control system and method are provided. In a first aspect, the laser control system comprises a master oscillator laser configured to generate a seed laser pulse train at a first repetition rate, an optical modulator configured to receive the pulse train from the master oscillator laser and modulate the pulse train based on a received modulation signal to generate modulated seed pulses, a laser amplifier configured to amplify the modulated seed pulses to generate an amplified pulse sequence output, and a control circuit for controlling the operation of the optical modulator. The control circuit is configured to receive a clock signal synchronized with the seed laser pulse train, receive a trigger input for asynchronous modulation of the seed laser pulse train, generate the modulation signal, and communicate the modulation signal to the optical modulator. The modulation signal is configured to control the optical modulator to selectively transmit and attenuate seed pulses from the seed laser pulse train to produce modulated seed pulses corresponding to the trigger input and attenuated to maintain a predetermined amplitude envelope in the pulse sequence output.

In another aspect, the control circuit generates the modulation signal using an algorithm based on the clock signal and the trigger input.

In a further aspect, the algorithm is executed on the control circuit.

In a further aspect, the control circuit is further configured to communicate with an external processor, and the algorithm is executed on the processor.

In a further aspect, the laser control system further comprises a sensor monitoring at least one characteristic of the amplified pulse sequence output and providing feedback to the control circuit, wherein the algorithm is further based on the feedback from the sensor.

In a further aspect, the algorithm self-calibrates based on the readings from the sensor.

In a further aspect, the algorithm further comprises a learning algorithm for pulse envelope control under arbitrary triggering.

In a further aspect, the algorithm determines the amount of attenuation of the modulation signal based on a timer that resets with each pulse in the trigger input.

In a further aspect, the predetermined amplitude envelope comprises an envelope having a burst energy set point.

In a further aspect, the predetermined amplitude envelope comprises an envelope having a burst amplitude set point.

In another example, a laser control circuit is provided for controlling the output of a laser. The control circuit is configured to receive a clock signal synchronized with a seed laser pulse train, receive a trigger input for asynchronous modulation of the seed laser pulse train, generate a modulation signal for controlling an optical modulator receiving the seed laser pulse train to selectively transmit and attenuate seed pulses from the seed laser pulse train to produce modulated seed pulses corresponding to the trigger input and attenuated to maintain a predetermined amplitude envelope of a pulse sequence output (230) after being amplified by a laser amplifier, and communicate the modulation signal to the optical modulator.

In another example, a method for controlling the output of a laser is provided. The method comprises receiving at a control circuit a clock signal synchronized with a seed laser pulse train, receiving at a control circuit a trigger input for asynchronous modulation of the seed laser pulse train, generating at a control circuit a modulation signal for controlling an optical modulator receiving the seed laser pulse train to selectively transmit and attenuate seed pulses from the seed laser pulse train to produce modulated seed pulses corresponding to the trigger input and attenuated to maintain a predetermined amplitude envelope of a pulse sequence output after being amplified by a laser amplifier, and communicating the modulation signal to the optical modulator.

Further aspects and examples will be apparent to a skilled person based on the description and claims.

### BRIEF DESCRIPTION OF THE DRAWINGS

Example embodiments of a laser control system and method will now be described in greater detail with reference to the accompanying drawings of example embodiments in which:

FIG. 1 is a time-domain diagram showing the operation of a conventional asynchronous pulse picker.

FIG. 2a is a block diagram showing components of a laser control system according to an example embodiment exhibiting first-pulse suppression for on-demand triggering using optical pre-compensation and having an open loop configuration.

FIG. 2b is a block diagram showing components of a laser control system according to a variant of the embodiment of FIG. 2a, this embodiment having a closed loop configuration.

FIG. 3 is a time-domain diagram showing a pre-compensation method to correct laser amplifier gain transients according to an example embodiment.

FIG. 4 is an oscilloscope trace showing first pulse suppression according to an example embodiment. The left trace shows the uncorrected pulse train. The right trace shows the corrected pulse train.

FIG. 5. is a simplified circuit diagram showing an example implementation of an asynchronous timing control circuit according to an example embodiment.

FIG. 6 is a diagram modeling a three-level laser energy system according to an example embodiment.

### DESCRIPTION OF EXAMPLE EMBODIMENTS

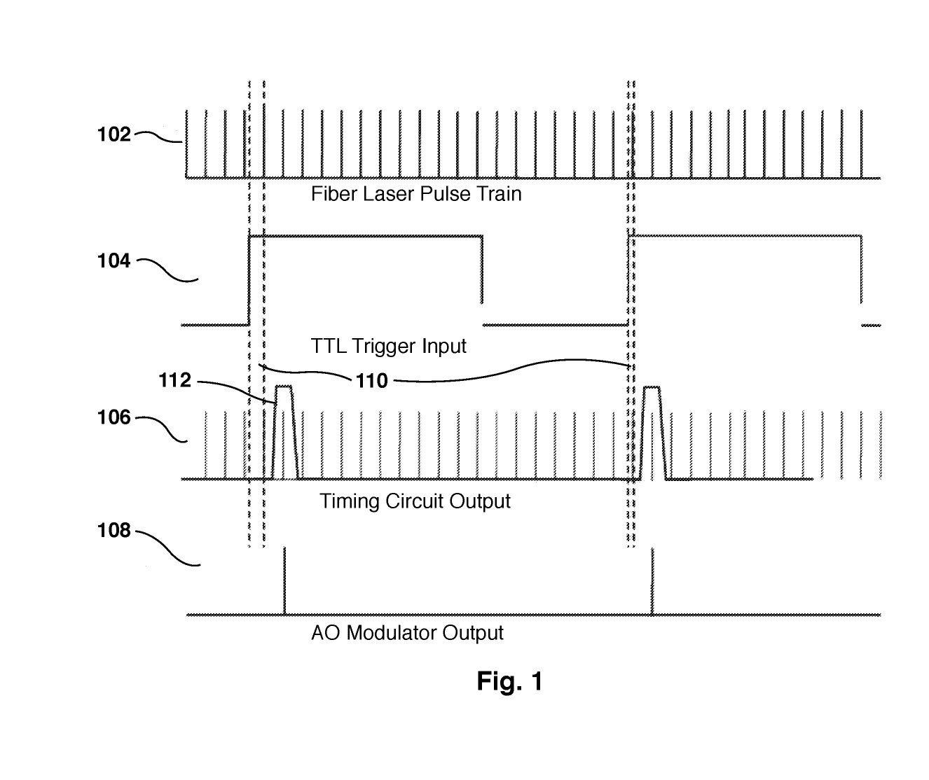

With reference to the drawings, FIG. 1 shows a basic asynchronous trigger scheme in which the trigger timing is not synchronized with the master oscillator repetition rate. This results in the timing resolution being limited to an integer factor of the steady state repetition rate of the pulse train. The fiber laser pulse train 102 generates pulses at a set repetition rate, such as 30 MHz. The trigger input 104, such as a transistor-transistor-logic (TTL) trigger input, may arrive at frequencies of 0 to 500 KHz in the illustrated example. The timing circuit output 106 is thus limited to pulses with envelopes 112 centered on pulse train 102 pulses occurring a full interval after the first pulse train pulse following the onset of the trigger input 104, leading to a static delay and jitter 110 that can in some cases be more than an interval long, where an interval is inversely proportional to the repetition rate of the pulse train 102. This timing circuit output 106 thus generates a final acousto-optical modulator output 108 with pulses centered on the timing circuit output 106 pulses and delayed from the onset of the trigger input 104 step function.

Direct modulation of the seed laser is an obvious alternative to modulation of the output. However, due to the excited state lifetime of the laser amplifier, prolonged periods without seed pulses lead to higher gain conditions for the leading edge of triggered pulse packets. This is known as the high energy “first pulse” effect.

Examples embodiments of the invention relate to a laser control circuit and method for enabling asynchronous, or ‘pulse on demand’ triggering of a Master Oscillator Power Amplifier (MOPA) laser system with controlled output pulse energy, by use of optical modulation and attenuation between the master oscillator (MO) seed pulses and the laser power amplifier (PA) to pre-compensate for transient gain effects in the PA in order to achieve arbitrary control of the envelope of the asynchronously modulated output pulse train.

In an example embodiment, the pump laser conditions are left constant, so as to minimize thermal relaxation effects, and the output of the laser system is modulated by controlling a fast optical attenuator between the seed laser and amplifier, with variable transmission to pre-compensate for transient gain in a laser amplifier system.

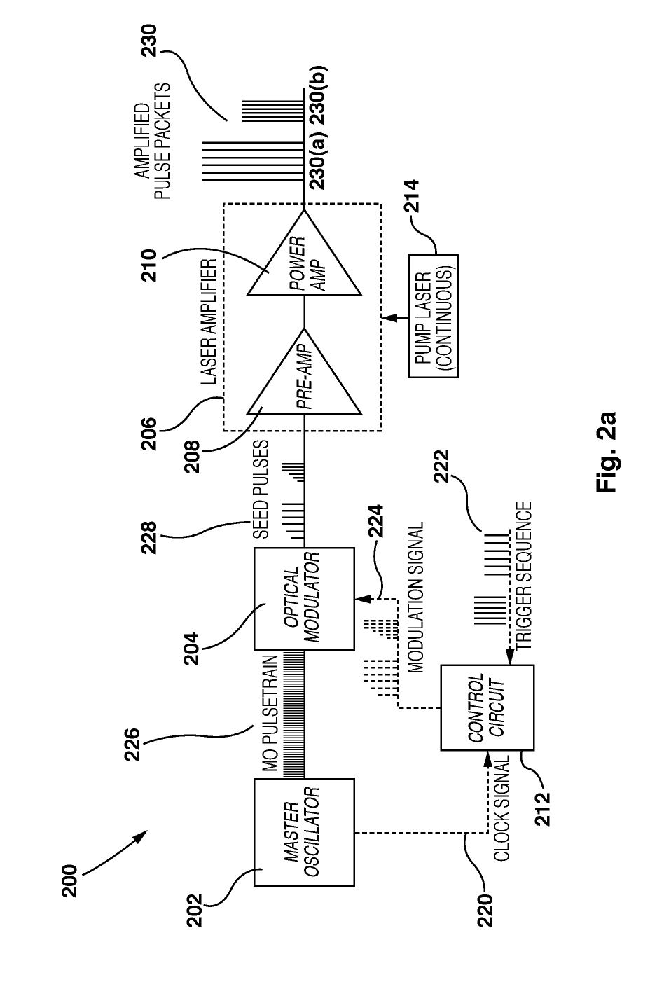

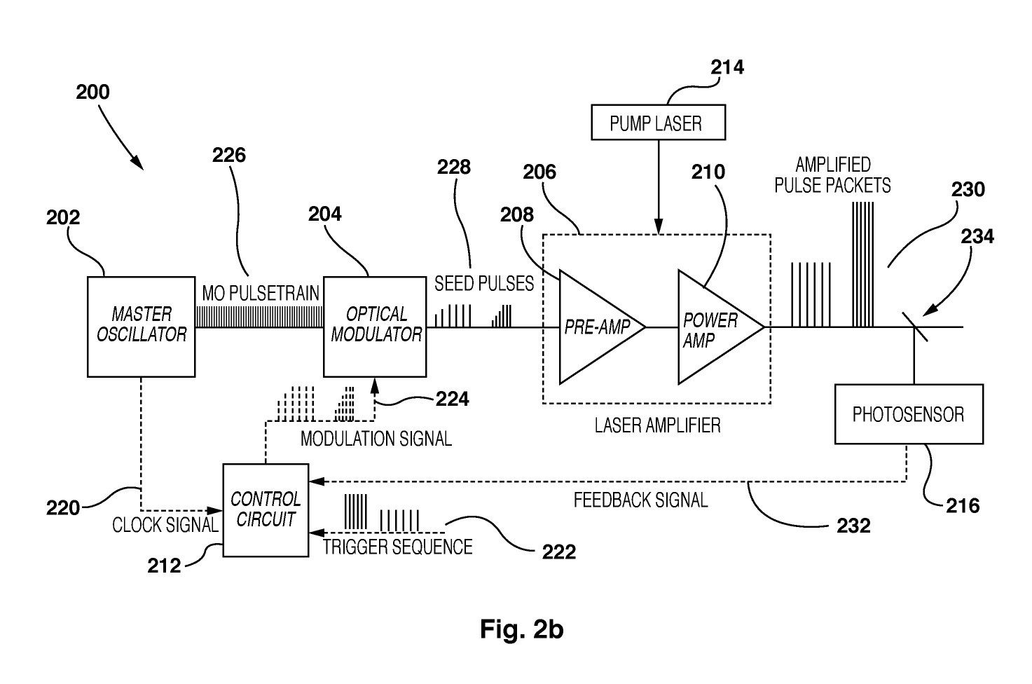

With reference to the drawings, FIG. 2a shows a block diagram of a laser control system 200 according to an example embodiment. In the illustrated embodiment, the laser control system 200 comprises a MOPA laser system in which the output pulses-train amplitude, duration, frequency, and phase are controlled by an electronic circuit driving an optical modulator. The system uses a master oscillator 202 acting as a pulse laser source which generates a pulse train 226 using a seed laser such as a fiber laser. The pulse train 226 is incident upon an optical modulator 204 which modulates the pulse train 226 to generate packets of modulated seed pulses 228. The operation of the optical modulator 204 is driven by a modulation signal 224 generated by an electronic control circuit 212, which receives a trigger sequence input 222 and a clock signal input 220 and generates the modulation signal 224 based on these inputs. In the illustrated embodiment, the clock signal 220 is generated by the master oscillator 202 based on the repetition rate of the pulse train 226. However, other embodiments could drive both the master oscillator 202 and the control circuit 212 using an independent clock signal 220.

The modulated seed pulses 228 generated by the optical modulator 204 are in turn incident on one or more laser amplifiers. In the illustrated embodiment, there is a single laser amplifier 206 comprising a pre-amplifier 208 and a power amplifier 210 and fed by a continuous pump laser 214. The modulation signal 224 generated by the control circuit 212 is shaped to result in packets of modulated seed pulses 228 incident on the one or more laser amplifiers 206 so as to produce a desired amplified output pulse sequence 230 of amplified pulse packets with controlled amplitude, duration, frequency and phase. In the illustrated embodiment, the output pulse sequence 230 has a set burst energy point for each burst of pulses: the left burst 230(a) with the lower repetition rate has a higher pulse amplitude, while the right burst 230(b) with the higher repetition rate has a lower pulse amplitude, thus generating two burst with equivalent energy.

In other embodiments, the desired envelope of the output pulse sequence 230 could be shaped using other criteria. For example, in one embodiment the envelope of the output pulse sequence 230 would be shaped to have a set predetermined flat amplitude regardless of other burst characteristics, such as repetition rate or duration of the burst. Some embodiments could have the desired envelope characteristics preset in the control circuit 212, while others could allow a user to program their own envelope characteristics into the system using the control circuit 212 or other processors or computers attached thereto (as further set out below).

Furthermore, some embodiments may use a trigger sequence input 222 with variable amplitude. The envelope of the output 230 may take the trigger input 222 amplitude into account; for example the system may generate an output envelope with an energy set point and/or amplitude set point dependent on the amplitude of the trigger input 222.

FIG. 2b shows a variant of the system in from FIG. 2a where the trigger input 222 has a variable amplitude which influences the amplitude of the system output 230. The variant embodiment in FIG. 2b also uses the amplifier output 230 to provide feedback to other components in the system. The amplifier output 230 is measured via a beam splitter 234 using a photo sensor 216, which provides a control signal 232 to the control circuit 212 to provide feedback used for self-calibration, as detailed further below.

The gain experienced by pulses in a laser amplifier with constant pumping conditions depends on the repetition rate of the modulated seed pulses 228. This is due to the lifetime of the excited state population in the laser gain material. Seeding with pulse periods shorter than the time required for re-population of the excited state results in less gain in the amplifier once the amplifier output power is saturated. Long pauses between bursts or packets of pulses can result in higher gain for the leading pulses, reducing pulse-to-pulse stability and possible optical damage to the laser amplifier. The present system and method may in some embodiments provide a method of pre-compensation of laser amplification transient characteristics by electronic controlled attenuation of the laser amplifier input pulses under steady state pumping conditions to achieve good envelope control of bursts of laser pulses.

In more detail, referring to the embodiments shown in FIGS. 2a and 2b, the master oscillator 202 produces a train of short pulses 226 at a given high repetition rate, e.g. >10 Mhz. The master oscillator 202 also includes a photodiode sensor or other means of generating an electrical clock signal 220 corresponding to the output pulse train 226. The control circuit 212 as shown includes a synchronizing gate circuit similar to the type used to in the context of trigger scheme described in FIG. 1 that selects which pulse or burst of pulses should be transmitted by the optical modulator 204 at a lower repetition rate, e.g. <10 Mhz. This decision may be determined by the external trigger sequence 222, or by a predetermined program governing the control circuit 212.

The following general equation describes the effect of the laser amplifier 206 on the seed pulses 228 in an example embodiment:

Iₒᵤₜ(t)=G(t)·Iᵢₙ(t)

Iᵢₙ(t)=α(t)·I_{MO}(t)

where Iₒᵤₜ is the laser output power flux (proportional to output pulse sequence 230) in units of [W/m̂2] and Iᵢₙ is the laser input power flux (seed pulses 228), a function of the I_{MO}(t) master oscillator power flux (pulse train 226) and the modulation signal α(t) 224. G(t) is the gain of the laser amplifier 206.

In a laser control system according to an example embodiment, G may be a complicated function, and analytical description of the complex combination of nonlinear optical elements may be difficult. However, an example is described herein below to provide a basis for creating a control algorithm for an example laser control system.

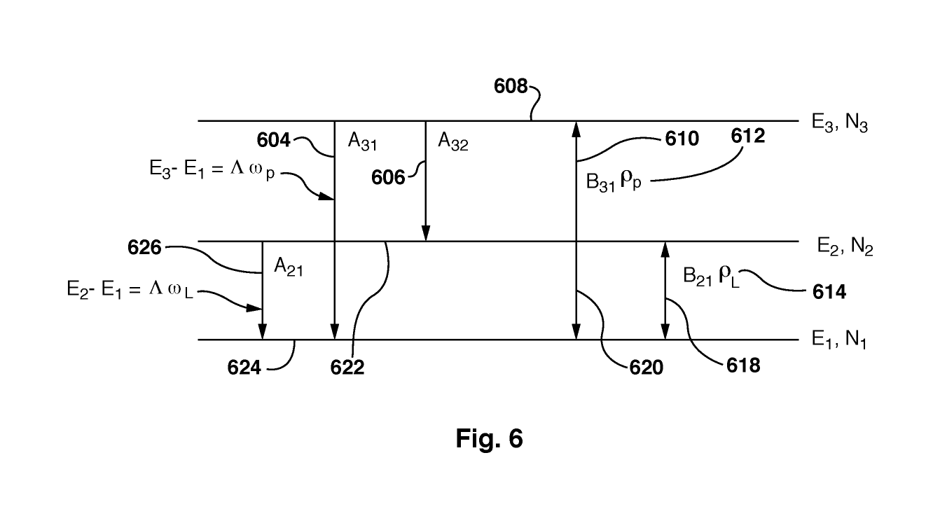

With reference to FIG. 6, the gain calculation can be modeled by the following three-level laser system population rate equation, where Nₙ is the population of level n. The system has three levels N₁ 624, N₂ 622, and N₃ 608.

$$\frac{d}{d t} {N}_{1} = {N}_{3} {A}_{31} + {N}_{2} {A}_{21} + ( {N}_{3} - {N}_{1} ) {B}_{31} {ρ}_{p} + ( {N}_{2} - {N}_{1} ) {B}_{21} {ρ}_{L}$$

$$\frac{d}{d t} {N}_{2} = {N}_{3} {A}_{32} - {N}_{2} {A}_{21} - ( {N}_{2} - {N}_{1} ) {B}_{21} {ρ}_{L}$$

$$\frac{d}{d t} {N}_{3} = - {N}_{3} {A}_{31} - {N}_{3} {A}_{32} - ( {N}_{3} - {N}_{1} ) {B}_{31} {ρ}_{p}$$

A₃₂ 606, A₃₁ 604, A₂₁ 626, are the rates of spontaneous emission, B₃₁ 610 and B₂₁ 618 are the rates of stimulated absorption and emission, ρ_{P}=U[I_{P}(t,ω)] 612 is the energy density of the pump laser, and ρ_{L}=U[Iᵢₙ(t,ω)] 614 is the energy density of the laser inside the amplifier which is a function of Iᵢₙ.

In this example the gain of the 3 level laser amplifier is a function of the population inversion ΔN(t) such that

$$G ( t ) = {g}_{0} {e}^{- κΔ N ( t )}$$

$$Δ N ( t ) = {N}_{2} - {N}_{1} = {\int }_{0}^{t} \frac{d ( {N}_{2} ( t ) - {N}_{1} ( t ) )}{d t} d t$$

The modulation signal α(t)=A(t)·P(t) where A(t) is the time dependant attenuation produced by the control circuit algorithm and P(t) is the desired pulse sequence and pre-specified envelope. The example above illustrates one possible approach for solving (numerically or otherwise) for the time dependant attenuation required from the algorithm used by the control circuit 212.

In one example configuration, the pulse sequence P(t) is defined by the asynchronous trigger 222 and pre-specified envelope shape. In another example configuration it is entirely specified by the control input of the timing circuit 322 as seen in FIG. 2b.

In a closed loop configuration as shown in FIG. 2b, the error between the pre-specified pulse envelope and the laser output can be expressed as ΔE=Iₒᵤₜ(t)/P(t−D) where D is the delay between the input of the control input of the timing circuit and the output of the laser amplifier and the modulation signal 224 α(t)=A(t,ΔE)·P(t).

Thus, the control circuit 212 in some embodiments includes a means of compensating for the transient changes in the laser amplifier 206 that result from changes in the timing between modulated seed pulses 228. This pre-compensation determines the amplitude of the modulation signal 224 going to the optical modulator 204, which alters the transmitted energy of the selected laser pulses.

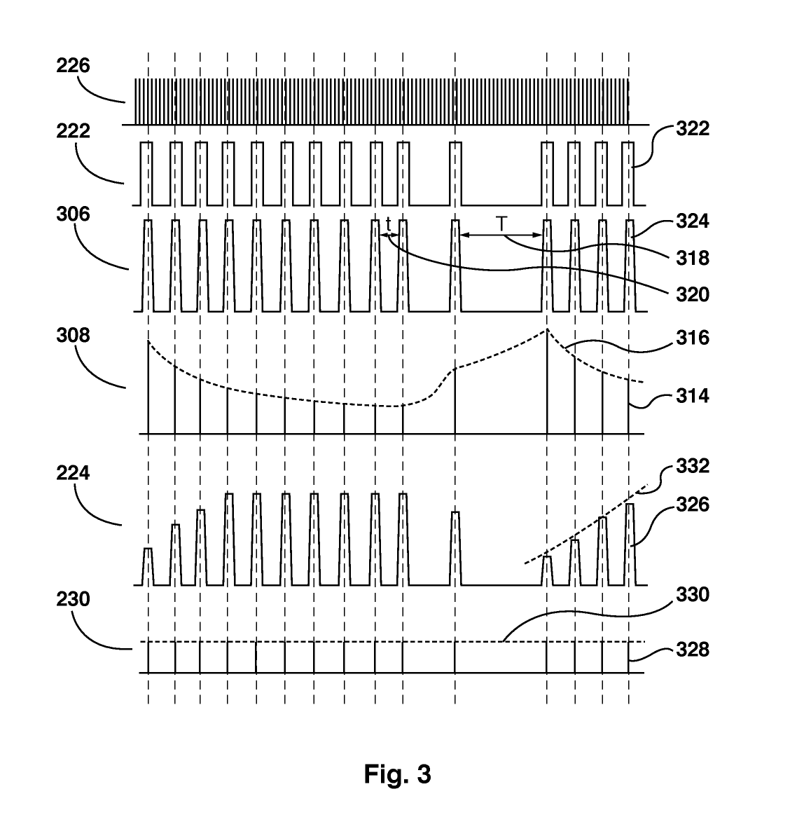

FIG. 3 shows an example of this pre-compensation method for correcting laser amplifier gain transients. The seed laser pulse train 226 has a high repetition rate. The asynchronous trigger input sequence 222 operates at a significantly lower frequency and exhibits packets or bursts or steps or pulses 322. Without attenuation or pre-compensation, the uncorrected modulator signal 306 produced by the control circuit 212 would exhibit pulses 324 having a flat gain. The interval between pulses in the same packet 320 would be a function of the repetition rate of the trigger sequence 222. The interval between different packets 318 would be significantly longer and would also be a function of the trigger sequence 222.

If this uncorrected modulator signal 306 were used and transmitted to the optical modulator 204, the amplified output pulse sequence generated by the amplifier 206 would appear as an uncorrected laser amplifier output 308 having pulses 314 of variable gain producing a non-flat envelope 316, and specifically pulses wherein gain would decay over the duration of a packet and would be at its maximum at the beginning of a packet after a long interval 318 for regeneration. This is the “first pulse problem” previously discussed.

In example embodiments of the present system and method, the control circuit instead pre-compensates for these regeneration and decay effects by generating a corrected modulator signal 224 (instead of uncorrected signal 306) having attenuated gain based on the previous pulse sequence and its effects on decay and regeneration. The pulses 326 of the corrected modulator signal 224 therefore have variable gain and adjustable decay 332 depending on their position within a packet, the duration between packets, the repetition rate of the trigger input 222, and potentially other factors.

Using the corrected modulator signal 224 results in a laser amplifier output 230 having packets of pulses 328 with a flat envelope 330 (as opposed to signal 308). Pulses that would have experience higher gain than their continuously seeded counterparts would in such a pre-compensation regime be attenuated to avoid excess pulse energy after the amplification by the laser amplifier 206.

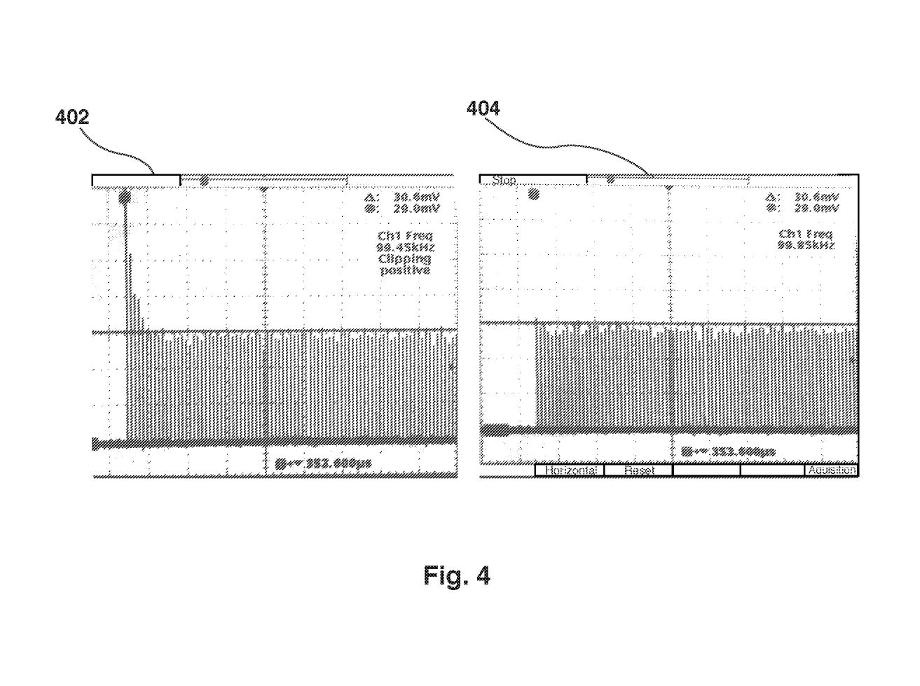

FIG. 4 illustrates the effect of the pre-compensation regime on laser amplifier output 230. The trace shown on the left 402 shows the uncorrected output pulse sequence 308 of the amplifier 206 resulting from an uncorrected modulator signal 306, while the trace on the right 404 shows a corrected amplifier output pulse sequence 230 resulting from a corrected modulator signal 224 using pre-compensation.

Advantages of this system and method of pre-compensation may include, in some embodiments, the ability to trigger the laser system with an external pulse sequence that is neither consistent in terms of repetition rate, nor synchronized to the master oscillator, while decoupling the output pulse energy from the external trigger timing.

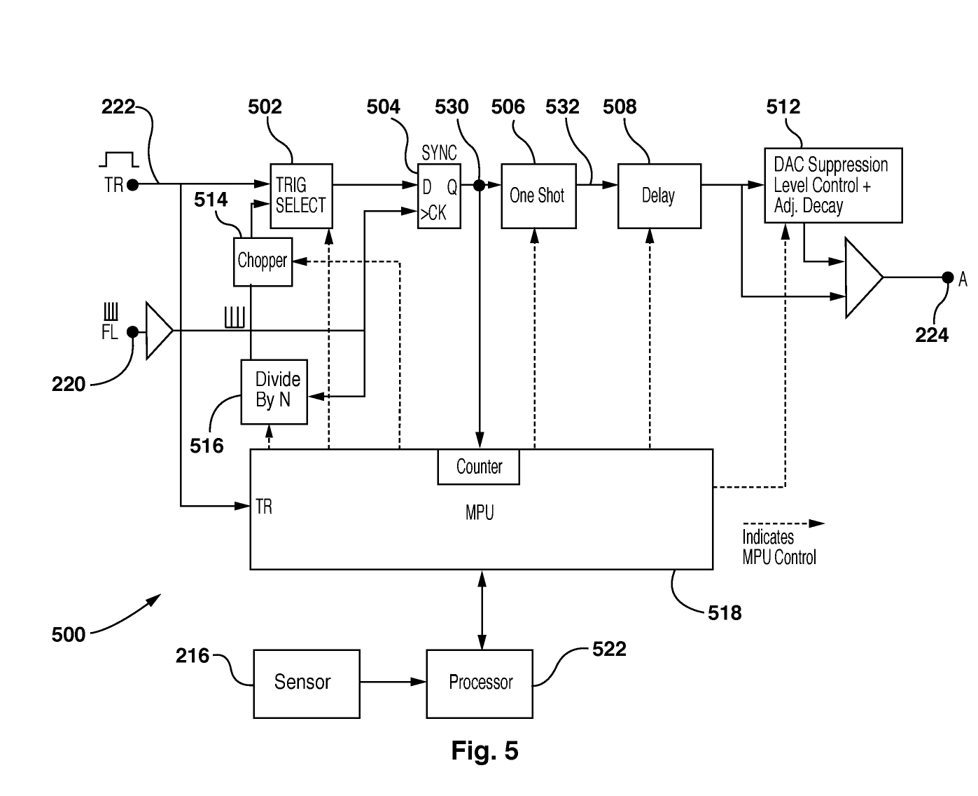

Thus, some embodiments may provide a MOPA laser system with an external trigger including a control circuit 212 that can be tuned to compensate for the power amplifier 206 transient response. A specific example embodiment 500 of the control circuit 212 is shown in FIG. 5. The clock signal 220 (in some embodiments generated by a photodiode included in the master oscillator 202) is used as the clock input to a flip-flop circuit 504 which synchronizes the trigger input signal 222. The trigger input 222 in some embodiments first feeds through a trigger select block 502 which takes as its select input a modified version of the clock signal 220 after it has fed through a Divide by N block 516 and a chopper block 514. The trigger select block 502 switches between the external trigger mode and an internal trigger mode, where the internal trigger mode uses a trigger signal generated by the microprocessor unit 518 (described below) having a known phase relationship with the clock signal 220. The flip-flop block 504 generates an output which used by a pulse length adjustable one shot circuit 506 to in turn generate an output pulse 532. The length of the pulse generated by the one shot circuit 506 is generally longer than optical pulse duration of the master oscillator 202 and shorter than the time between pulses of the clock signal 220 to act as a gate for individual pulses—for example, they may resemble the timing circuit output envelopes 112 shown in FIG. 1, with the width of envelope 112 dictated by the pulse length of the one shot circuit 506. In some embodiments, the system may operate in a pulse burst mode, where the length of the one shot circuit 506 may be increased to transmit multiple pulses from the master oscillator 202 as a burst of pulses entering the amplifier 206. A phase delay 508 is used in conjunction with a digital-analog-converter (DAC) 512 implementing the pre-compensation attenuation (and responsible for creating the adjustable decay 332 seen in FIG. 3) to align the optical modulator signal 224 with the pulse train from the master oscillator 202. A microprocessor unit (MPU) 518 receives the sync block output signal 530 as a counter input, receives the asynchronous trigger input 222 as a further input, and exercises control over the various blocks and components of the control circuit 212, including in some embodiments the Divide by N block 516, the trigger select block 502, the one shot circuit 506, the delay block 508, and the DAC 512. The DAC 512 controlled by the MPU 518 acts as a suppression circuit which adjusts the amplitude of the optical modulator 204 by adjusting the amount and time profile of the suppression.

In some embodiments, the gain calculations used in the pre-compensation and suppression regime are made within the control circuit 212 hardware itself, while in other embodiments the calculations are made externally, e.g. by a processor 522 or computer in communication with the control circuit 212. These calculations may take into account various factors in different embodiments, including the position of the present pulse within a packet, the duration between packets, the repetition rate of the trigger input 222, and potentially other factors. In one example embodiment, the pre-compensation gain attenuation calculation is based on the value of a timer that resets after each pulse. Some embodiments may make use of a memory to store and look up past patterns of modulation and output, and to base present pre-compensation calculations on such memory lookups.

In some embodiments, such as the variant shown in FIG. 2b, the amplifier output 230 is used to provide feedback to other components in the system. Some embodiments may measure the amplifier output 230 via a beam splitter 234 using a sensor, such as a photo sensor 216 or a power meter, and provide these readings as a feedback control signal 232 to the control circuit 212 or a computer or processor 522 controlling the control circuit 212. These readings may allow the computer to self-calibrate the system. Some embodiments using such a measurement technique may further include an algorithm implemented by the computer to learn over time and thereby control the pulse envelope under arbitrary triggering. This algorithm would adjust the available control to achieve the pre specified amplitude envelope and sequence of pulses. In one such embodiment, the algorithm might compare the two output traces of FIG. 4 and use the standard deviation of the corrected trace 404 as a fitness function, calibrating to minimize this value. Another algorithm could compare the corrected trace 404 to a desired output envelope and train the system to minimize this value instead. Any of the number of other fitness functions could be employed to auto-calibrate the system to produce output more accurately adhering to a desired mode of operation.

In some embodiments, the optical modulator 204 could be implemented as two or more optical modulators operating in conjunction, either in parallel or in sequence, to produce the modulator output 228 from one or more pulse train inputs 226.

In some embodiments, the control circuit 212 could be implemented as a general purpose computer or processor, such as a general purpose computer having specialized hardware for high-speed acoustic processing.

While the described embodiments have shown the feedback signal from the photo sensor 216 as a single control signal 232, such as a sensor reading of output amplitude, some embodiments may use one or more sensors or other components to provide a plurality of control signals 232 used to train or auto-calibrate the pre-compensation algorithm used by the control circuit 212.

The present disclosure may be embodied in other specific forms without departing from the full scope of the claims as read in light of the specification as a whole, and would be understood by a person of skill in the art to encompass various sub-combinations and variants of described features. The described embodiments are to be considered in all respects as being only illustrative and not restrictive. The present disclosure intends to cover and embrace all suitable changes in technology.

What is claimed is:

1. A laser control system comprising:
a master oscillator laser configured to generate a seed laser pulse train at a first repetition rate;
an optical modulator configured to receive the pulse train from the master oscillator laser and modulate the pulse train based on a received modulation signal to generate modulated seed pulses;
a laser amplifier configured to amplify the modulated seed pulses (228) to generate an amplified pulse sequence output; and
a control circuit for controlling the operation of the optical modulator configured to:
receive a clock signal synchronized with the seed laser pulse train;
receive a trigger input for asynchronous modulation of the seed laser pulse train;
generate the modulation signal; and
communicate the modulation signal to the optical modulator, wherein the modulation signal (224) is configured to control the optical modulator (204) to selectively transmit and attenuate seed pulses from the seed laser pulse train (226) to produce modulated seed pulses (228) corresponding to the trigger input (222) and attenuated to maintain a predetermined amplitude envelope in the pulse sequence output (230).

2. The laser control system of claim 1, wherein the control circuit generates the modulation signal using an algorithm based on the clock signal and the trigger input.

3. The laser control system of claim 2, wherein the algorithm is executed on the control circuit.

4. The laser control system of claim 2, wherein the control circuit is further configured to communicate with an external processor, and wherein the algorithm is executed on the processor.

5. The laser control system of claim 2, further comprising a sensor monitoring at least one characteristic of the amplified pulse sequence output and providing feedback to the control circuit, wherein the algorithm is further based on the feedback from the sensor.

6. The laser control system of claim 5, wherein the algorithm self-calibrates based on the readings from the sensor.

7. The laser control system of claim 2, wherein the algorithm further comprises a learning algorithm for pulse envelope control under arbitrary triggering.

8. The laser control system of claim 2, wherein the algorithm determines the amount of attenuation of the modulation signal based on a timer that resets with each pulse in the trigger input.

9. The laser control system of claim 1, wherein the predetermined amplitude envelope comprises an envelope having a burst energy set point.

10. The laser control system of claim 1, wherein the predetermined amplitude envelope comprises an envelope having a burst amplitude set point.

11. A laser control circuit for controlling the output of a laser, configured to:
receive a clock signal synchronized with a seed laser pulse train;
receive a trigger input for asynchronous modulation of the seed laser pulse train; and
generate a modulation signal for controlling an optical modulator receiving the seed laser pulse train to selectively transmit and attenuate seed pulses from the seed laser pulse train to produce modulated seed pulses corresponding to the trigger input and attenuated to maintain a predetermined amplitude envelope of a pulse sequence output after being amplified by a laser amplifier.

12. The laser control circuit of claim 11, wherein the control circuit generates the modulation signal using an algorithm based on the clock signal and the trigger input.

13. The laser control circuit of claim 12, wherein the algorithm is executed on the control circuit.

14. The laser control circuit of claim 12, wherein the control circuit is further configured to communicate with an external processor, and wherein the algorithm is executed on the processor.

15. The laser control circuit of claim 12, further configured to receive feedback from a sensor monitoring at least one characteristic of the amplified pulse sequence output, wherein the algorithm is further based on the feedback from the sensor.

16. The laser control circuit of claim 15, wherein the algorithm self-calibrates based on the readings from the sensor.

17. The laser control circuit of claim 12, wherein the algorithm further comprises a learning algorithm for pulse envelope control under arbitrary triggering.

18. The laser control circuit of claim 12, wherein the algorithm determines the amount of attenuation of the modulation signal based on a timer that resets with each pulse in the trigger input.

19. The laser control circuit of claim 11, wherein the predetermined amplitude envelope comprises an envelope having a burst energy set point.

20. The laser control circuit of claim 11, wherein the predetermined amplitude envelope comprises an envelope having a burst amplitude set point.

21. A method for controlling the output of a laser, comprising:
receiving at a control circuit a clock signal synchronized with a seed laser pulse train;
receiving at a control circuit a trigger input for asynchronous modulation of the seed laser pulse train; and
generating at a control circuit a modulation signal for controlling an optical modulator receiving the seed laser pulse train to selectively transmit and attenuate seed pulses from the seed laser pulse train to produce modulated seed pulses corresponding to the trigger input and attenuated to maintain a predetermined amplitude envelope of a pulse sequence output after being amplified by a laser amplifier.

22. The method of claim 21, wherein the control circuit generates the modulation signal using an algorithm based on the clock signal and the trigger input.

23. The method of claim 22, wherein the algorithm is executed on the control circuit.

24. The method of claim 22, further comprising:
communicating the clock signal and the trigger input from the control circuit to an external processor;
executing the algorithm on the processor to determine admittance and attenuation data for the modulation signal; and
communicating the admittance and attenuation data from the processor to the control circuit.

25. The method of claim 22, further comprising receiving feedback from a sensor monitoring at least one characteristic of the amplified pulse sequence output, and wherein the algorithm is further based on the feedback from the sensor.

26. The method of claim 25, wherein the algorithm self-calibrates based on the readings from the sensor.

27. The method of claim 22, wherein the algorithm further comprises a learning algorithm for pulse envelope control under arbitrary triggering.

28. The method of claim 22, wherein the algorithm determines the amount of attenuation of the modulation signal based on a timer that resets with each pulse in the trigger input.

29. The method of claim 21, wherein the predetermined amplitude envelope comprises an envelope having a burst energy set point.

30. The method of claim 21, wherein the predetermined amplitude envelope comprises an envelope having a burst amplitude set point.
